(19) United States
(12) Patent Application Publication
(10) Pub. No.: US 2009/0068623 A1
(43) Pub. Date: Mar. 12, 2009

(54) Method to determine that a person possesses analysis and synthesis skills

(76) Inventor: William Burnett, Libertyville, IL (US)

Correspondence Address: WILLIAM RICHARD BURNETT, 413 SECOND AVENUE, LIBERTYVILLE, IL, 60048, US

(21) Appl. No.: 11/853,011

(22) Filed: Sep. 10, 2007

(51) Int. Cl. G09B 19/00

(52) U.S. Cl. 434/128

(57) ABSTRACT

A method for demonstrating a person has strong analytic and synthetic ability. The subject is presented with a carefully chosen puzzle or problem, which is fairly easy to solve using trial and error, but which also can be solve by using analysis and synthesis. The subject is instructed to solve the puzzle without using trial and error and to describe or document their method. Where the subject successfully describes the steps such that they follow a logical flow and lead correctly to the solution, the subject has demonstrated analytic and synthetic ability in a verifiable way.

### BACKGROUND OF THE INVENTION

Many in business and other entities, today, feel nothing is more important to success than innovation. Two identified skills, which enable breakthrough innovation, are

keen analytic ability (the ability to define; take apart; describe characteristics; understand relevant components of problems and opportunities), and

strong synthesis ability (the ability to take knowledge and the information disclosed in analysis and to infer relationships among characteristics or disparate ideas to build a solution by combining ideas)

Identifying persons with good analytic and synthetic skill levels is important to business or any area where innovation plays an important role.

In the same way that almost every person has some artistic capability, almost every person has some analytic and synthetic ability. The first time an infant sees (Note: drawing removed to separate document) this block puzzle (FIG. 1) and is shown how the blocks fit into the holes, the infant will usually try to put the round block in the square hole (after putting it in his or her mouth, of course), the triangle in the round hole, etc. Eventually, through this trial and error process the infant will get the right blocks into the right holes. If you give the same puzzle to an adult, the adult does not use trial and error, but immediately puts the right blocks into the right holes. Although the adult typically does not consciously realize it, they are doing analysis and synthesis. The adult analyzes the shapes of the blocks and the shapes of the holes, and does the simple synthesis to match the two items together.

Like artistic ability, different persons have different levels of analysis and synthesis abilities.

It is common in the prior art to evaluate behavioral capabilities through measurement methods, systems and apparatuses. U.S. Pat. No. 5,365,425 issued to Torma discloses a method and system for measuring management effectiveness. U.S. Pat. No. 5,344,324 issued to O'Donnell discloses a method and apparatus for testing capability to perform tasks requiring switching of skills. U.S. Pat. No. 5,135,399 issued to Ryan describes a method for evaluating and teaching motivation skills. U.S. Pat. No. 5,082,416 issued to Sclan discloses a process for the adaptation of cognitive and psychological tests for use in the assessment of dementia patients. U.S. Pat. No. 4,770,636 issued to Buschke discloses instrumentation for measuring memory and concentration. U.S. Pat. No. 4,755,140 issued to Rimland discloses a hand held apparatus and method to measure reaction time and awareness. U.S. Pat. No. 4,627,818 issued to Von Fellenberg discloses a self-assessment method and apparatus for measuring relative disposition towards particular tasks.

Other methods are used in education to measure analytic ability such as the college entrance exam SAT. Or the MAT, a high-level, analytic ability test that requires the solution of problems stated as analogies. It consists of 120 partial analogies that are to be completed in 60 minutes.

Employers use interview methods to ask questions to determine a person's ability to perform analysis and synthesis. E.g. questions like: “Describe a problem you faced, how you analyzed it and how you came up with a solution?”.

Puzzles have been used in various ways in education and entertainment and are discussed in:

http://darkwing.uoregon.edu/˜moursund/Books/Games/Games4.pdf In this discussion puzzles have not been used to determine that a person has analytic and synthetic skill. The closest reference to these skills is the assertion that doing some puzzles may help develop these skills.

It is apparent from even this brief summary of prior art and confirmed by more extensive search by the inventor that a verifiable method for demonstrating a persons analytic and synthetic ability has not be described. Current methods can imply analytic ability based on responses to interview questions or tests like the MAT which use analogies. Demonstration of synthesis ability is also inferred from past performance or answers to interview questions about past performance.

This invention provides a method to demonstrate analytic and synthetic ability in a unambiguous and verifiable way. With this method, a business or other entity can detect and employ these skills more precisely.

### BRIEF SUMMARY OF THE INVENTION

Various mathematical/logic puzzles are easy to solve using a trial and error method and therefore persons select trial and error as the solution method because it is apparently the most efficient method.

This invention asks the person to describe or document the step taken to solve the puzzles without using trial and error. To do this, a person must use analysis and synthesis. If the person is able to, and uses analysis and synthesis, the description of the solution will evidence a clear step-by-step logical flow from information defined during analysis, to the solution obtained by combining that information in ways that prove the solution.

### DETAILED DESCRIPTION OF THE INVENTION

The purpose of the invention is to determine that the person utilizes analysis and synthesis to solve a problem. By way of an example, a puzzle, such as the one below (which is solvable using trial and error or can be solved using analysis and synthesis, there are many such puzzles) is given to the person to solve.

The instructions state: (FIG. 2) Place the numbers 1,2,3,4,5,6,7,8,9 into the 9 squares such that when three numbers are added together in rows, columns or diagonally, they add to 15. List the analysis and steps you would take to solve this problem without using the trial and error method.

This paragraph contains an example of a solution evidencing Analysis and Synthesis ability:

### Sums to 15 Puzzle—Analytic Solution

In the grid there are three vertical sums, three horizontal sums and two diagonal sums which equal a total of 8 combinations of three digit numbers adding up to 15. Since you need to use each of the numbers 1-9 and there are 9 boxes, the combinations of each of the eight three-digit sums is unique.

Eliminated the smallest number of possible three digit sums that would obviously not equal 15.

Eliminated the largest of possible three digit sums that would obviously exceed 15.

Identified all the of possible three digit sums that equal 15, and listed them (FIG. 3). As expected there are 8 unique combinations of three digit numbers which add up to 15.

Count the number of occurrences of each digit 1-9 in FIG. 3 (FIG. 4)

Determine in each square of the grid, how many three digit sums intersected in the square. For example, the square in the upper left corner has three sums intersect in the square (FIG. 5).

That means the following number of intersection per square (FIG. 6): Based on this geometry, the number 5 has to go in the center square since it is the only number involved in four sums (FIG. 4). The even numbers (2,4,6,8) must go in the corners since they are each involved in three sums, and the remaining odd numbers (1,3,7,9) go in the middle boxes around the edge (highlighted in yellow).

The number 9 cannot be present in any column or row which also contains the numbers 6, 7, or 8, because those two number alone equal or exceed 15. Since 6 and 8 must be in corners they must be in corners on the opposite edge of whichever yellow square in which you put the number 9.

And from FIG. 3 above, between the two corners where you put the numbers 6 and 8 you must place the number 1 (to add to 15). The number 1 is directly opposite the number 9 and since the number 5 is in the middle, it adds correctly.

You placed the Number 8 in a corner in line with the numbers 1 and 6. Since the number 5 is in the middle, the opposite corner of where you placed the number 8, must be the number 2 (from FIG. 3 above). This leaves the number 4 to be placed in the opposite corner and in line with the number 8. Between the 4 and the 8 you must place the number 3 and that only leave the number 7 which now goes in the only available empty box, which is between the number 6 and the number 2. You only need verify that the row or column containing the 7, 5, 3 is correct as is the diagonal 4, 5, and 6 (FIG. 7). Done.

In the example above, the conclusions made are correctly derived from the mathematical or geometrical characteristics of the problem. The logical flow is correct and provides verifiable, documented evidence that the person used an analytic and synthetic approach to solve the problem

Examples of solutions which do not demonstrate the use of good analytic and synthetic ability contain statements like “the number 5 is in the mid-point between 1-9, therefore it must be in the middle position.” Or “there are only four even numbers so they must be in the corners.” These statements do not evidence good analytic and synthetic ability since the conclusions don't necessarily follow from the premises.

### A BRIEF DESCRIPTION OF THE SEVERAL VIEWS OF THE DRAWINGS

FIG. 1 contains an image of a child's toy consisting of block and a raised platform containing holes which match the shapes of the blocks.

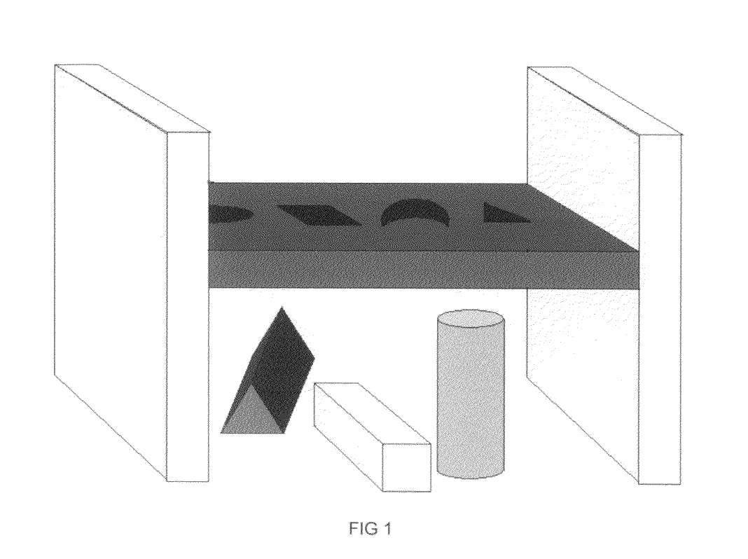

FIG. 2 contains an image of the puzzle three by three square grid showing that each row, column, and diagonal combination of 3 squares adds to the number 15.

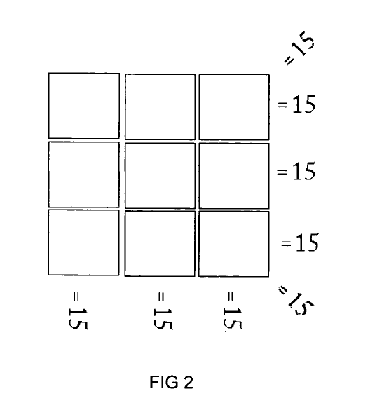

FIG. 3 is a table showing the possible combinations of three numbers in the range 1-9 which sum to 15.

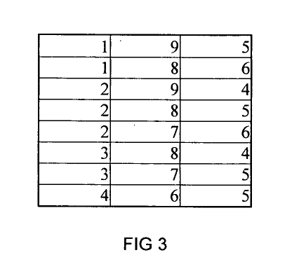

FIG. 4 is a table with lists the number of occurrence in FIG. 3 of each digit 1-9.

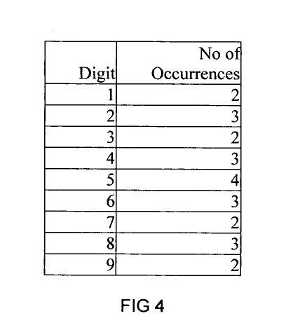

FIG. 5 contains an image demonstrating by arrows, the number of 3 digit sums the upper left square is involved in.

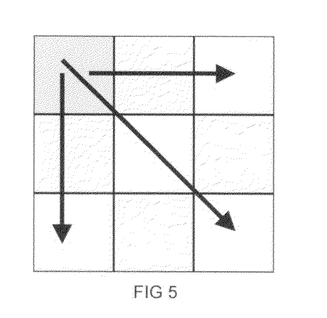

FIG. 6 contains an image of the grid with the number of sums each square in the grid is involved in.

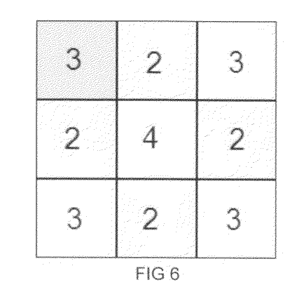

FIG. 7 contains an image of the grid containing a correct solution to the puzzle.

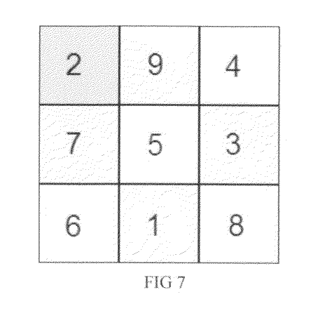

1. A verifiable method for demonstrating a person's analytic and synthetic ability. The method uses a puzzle or problem, which can be solved using analytic and synthetic ability. The person is instructed to solve the puzzle or problem without using trial and error, and to describe or document the steps and conclusions used to solve the puzzle or problem. Where the description or documentation provides true and logical steps which lead to a correct solution of the puzzle or problem, then the person's use of analysis and synthesis has been verified.

2. A method to help teach the difference between experimentation (trial and error) and analysis/synthesis in solving problems or finding new innovation.
